(19) United States
(12) Patent Application Publication
(10) Pub. No.: US 2026/0017390 A1
(43) Pub. Date: Jan. 15, 2026

(54) KEYBOARD REMOTE CONTROL SYSTEM AND KEYBOARD REMOTE CONTROL METHOD

(71) Applicant: Getac Technology Corporation, New Taipei City (TW)

(72) Inventor: Chia-Chang CHIU, Taipei City (TW)

(21) Appl. No.: 19/262,370

(22) Filed: Jul. 8, 2025

(30) Foreign Application Priority Data
Jul. 9, 2024 (TW) 113125697

(51) Int. Cl. G06F 21/60; G06F 3/02; G06F 8/61; G06F 40/279

(52) U.S. Cl. CPC G06F 21/606; G06F 3/02; G06F 8/61; G06F 40/279

(57) ABSTRACT

A keyboard remote control method includes responding to an activation of an electronic device, lock a keyboard connection unit of the electronic device through an embedded controller of the electronic device before an operation system of the electronic device is executed. The keyboard remote control method further includes executing a keyboard monitoring software through the electronic device to control the embedded controller to unlock or lock the keyboard connection unit.

### CROSS-REFERENCE TO RELATED APPLICATION

This application claims priority to Taiwan Application Serial Number 113125697, filed Jul. 9, 2024, which is herein incorporated by reference.

### BACKGROUND

### Field of Disclosure

The present disclosure relates to a keyboard remote control system and keyboard remote control method.

### Description of Related Art

The keyboard control in current technology is performed by capturing keyboard input with a program to intercept inappropriate input after the operating system of the electronic device is executed.

However, in certain electronic device usage scenarios, such as police or military use, such method cannot prevent improper reinstallation of the operating system and data theft. In addition, if only specific keys are allowed to be used and the user is unable to set disabled keys, the software operation may be disrupted due to unintended shortcut key activations.

Therefore, it is of critical importance to provide a keyboard control system and control method that can solve the problems above is still a goal that the people in this filed has been working hard to develop.

### SUMMARY

One aspect of the present disclosure includes a keyboard remote control method.

In some embodiments, the keyboard remote control method includes responding to an activation of an electronic device, locking a keyboard connection unit of an electronic device through an embedded controller of the electronic device before an operation system of the electronic device is executed; and executing a keyboard monitoring software through the electronic device to control the embedded controller to unlock or lock the keyboard connection unit.

In some embodiments, the keyboard remote control method further includes determining whether the keyboard monitoring software is installed in the electronic device through the embedded controller after the operation system of the electronic device is executed.

In some embodiments, when no keyboard monitoring software is installed in the electronic device, the embedded controller locks the keyboard connection unit of the electronic device.

In some embodiments, the keyboard remote control method further includes defining a user-defined keyboard configuration through a backend server; and providing the user-defined keyboard configuration to the electronic device to control a keyboard connected with the electronic device through an application interface connected with the keyboard monitoring software.

In some embodiments, defining the user-defined keyboard configuration through the backend server further includes defining a disabled key and an enabled key.

In some embodiments, the keyboard remote control method further includes executing the keyboard monitoring software through the electronic device to choose a user-defined keyboard configuration corresponding to a usage scenario.

In some embodiments, the keyboard remote control method further includes executing the keyboard monitoring software through the electronic device to receive an input string in real-time based on a user-defined keyboard configuration; and executing a text filter through the electronic device to determine whether the input string contains a restricted keyword or a uniform resource locator (URL).

In some embodiments, when the input string contains the restricted keyword or the URL, the keyboard remote control method further includes locking the keyboard connection unit through the embedded controller of the electronic device.

In some embodiments, the keyboard remote control method further includes transmitting an unlock command to the electronic device through a backend server after the embedded controller of the electronic device locks the keyboard connection unit of the electronic device.

In some embodiments, when the input string contains the restricted keyword or URL, the keyboard remote control method further includes when the input string contains the restricted keyword or the URL, the keyboard remote control method further.

Another aspect of the present disclosure is a keyboard remote control system.

In some embodiments, the keyboard remote control system includes an electronic device. The electronic device includes a keyboard connection unit, an embedded controller, and a first processor. The embedded controller is configured to lock the keyboard connection unit of the electronic device before an operation system of the electronic device is executed. The first processor is configured to read at least one command stored in a first storage unit so as to execute the following step: controlling the embedded controller to unlock or lock the keyboard connection unit.

In some embodiments, the embedded controller is configured to determine whether the first storage unit of the electronic device contains a command used to receive an input string in real-time after executing the operation system of the electronic device.

In some embodiments, the keyboard remote control system further includes a backend server configured to define a user-defined keyboard configuration. The backend server includes a second processor configured to read the user-defined keyboard configuration stored in a second storage unit, and an application interface connected with the first processor of the electronic device. The application interface is configured to provide the user-defined keyboard configuration to the electronic device so as to control a keyboard connected with the electronic device.

In some embodiments, the user-defined keyboard configuration includes a disabled key and an enabled key.

In some embodiments, the keyboard connection unit includes a universal serial bus (USB) port or a Bluetooth.

In some embodiments, the first processor of the electronic device is further configuring to determine whether an input string contains the restricted keyword or a uniform resource locator (URL).

In some embodiments, when the input string contains the restricted keyword or the URL, the embedded controller of the electronic device is configured to lock the keyboard connection unit of the electronic device.

In some embodiments, the keyboard remote control system further includes a backend server. After the embedded controller of the electronic device locks the keyboard connection unit of the electronic device, the backend server is configured to transmit an unlock command to the electronic device.

In some embodiments, the first processor is further configured to choose the user-defined keyboard configuration corresponding to a usage scenario.

In some embodiments, the electronic device is further configured to display a determination result.

In the aforementioned embodiments, the keyboard remote control method of the present disclosure only allow unlocking the keyboard connection unit to avoid unauthorized operation system reinstallation or data theft when the electronic device is determined to have a keyboard monitoring software and is authorized by using the embedded controller to lock the keyboard connection unit before the operation system is executed by the electronic device. Since the above-mentioned control method can be achieved through the remote control, the keyboard can be locked immediately to avoid inappropriate use even when the electronic device is lost or falls into a third party.

### BRIEF DESCRIPTION OF THE DRAWINGS

FIG. 1 is a block diagram of a keyboard remote control system according to one embodiment of the present disclosure.

FIG. 2 is a block diagram of a keyboard remote control system according to another embodiment of the present disclosure.

FIG. 3 is a flow chart of a keyboard remote control method according to an embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

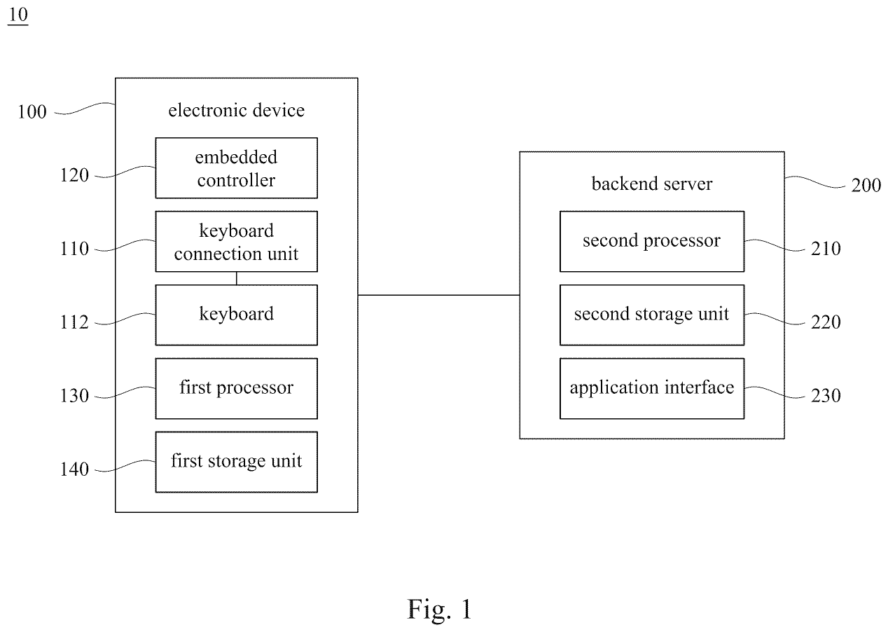

FIG. 1 is a block diagram of a keyboard remote control system 10 according to one embodiment of the present disclosure. The keyboard remote control system 10 includes an electronic device 100 and a backend server 200. The electronic device 100 includes a keyboard connection unit 110, an embedded controller 120, a keyboard 112, a first processor 130, and a first storage unit 140. The backend server 200 includes a second processor 210, a second storage unit 220, and an application interface 230.

The electronic device 100 may take the form of a laptop, a notebook computer, a desktop computer, a tablet computer or other portable electronic devices. The backend server 200 may take the form of a data center, such as a tower server, a rack server, or a blade server.

The electronic device 100 and the backend server 200 are connected through network communication. The communication connection method of the network complies with the IEEE 802.11 standard (e.g., Wifi), Bluetooth, ZigBee, near field communication, or any other suitable wireless communication standard device communication. In some embodiments, the communication device may be, for example but not restricted to, a device that complies with Ethernet, Universal Serial Bus (USB) or any other suitable wired transmission communication standard.

The keyboard connection unit 110 of the present embodiment is connected with a built-in keyboard 112. The hardware implementation of the embedded controller 120 is realized by embedded microelectronic chips so as to execute controlling, monitoring or supporting other operation functions in real-time. The keyboard connection unit 110 may be electronic elements between the embedded controller 120 and the keyboard 112 used to receive and process the unlocking or locking signals of the keyboard 112.

Before the electronic device 100 executes the operation system, the embedded controller 120 is configured to lock the keyboard connection unit 110 of the electronic device 100. After the electronic device 100 executes the operation system, the embedded controller 120 is configured to determine whether the first storage unit 140 of the electronic device 100 contains the command used to receive an input string in real-time. The first processor 130 reads this command to execute keyboard monitoring.

The first processor 130 is used to read the command stored in the first storage unit 140 to control the embedded controller 120 to unlock or lock the keyboard connection unit 110. The first processor 130 is configured to choose the user-defined keyboard configuration corresponding to a usage scenario.

The first processor 130 is further configured to determine whether an input string contains a restricted keyword or URL, and the electronic device 100 is used to display a determination result. When the first processor 130 determined that the input string contains the restricted keyword or URL, the embedded controller 120 of the electronic device 100 is configured to lock the keyboard connection unit 110 of the electronic device 100.

The backend server 200 is configured to define a user-defined keyboard configuration. After the embedded controller 120 of the electronic device 100 locks the keyboard connection unit 110, the backend server 200 is configured to transmit the unlock command to the electronic device 100.

The first processor 130 and the second processor 210 may be a central processing unit (CPU), or other programmable general-purpose or special-purpose micro control unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (field programmable gate array (FPGA), or other similar elements or combinations of the above elements.

The storage units 140, 220 may be any type of fixed or removable random access memory (RAM), read-only memory (ROM), flash memory, hard disk drive (HDD), solid state drive (SSD) or similar elements or a combination of the above elements.

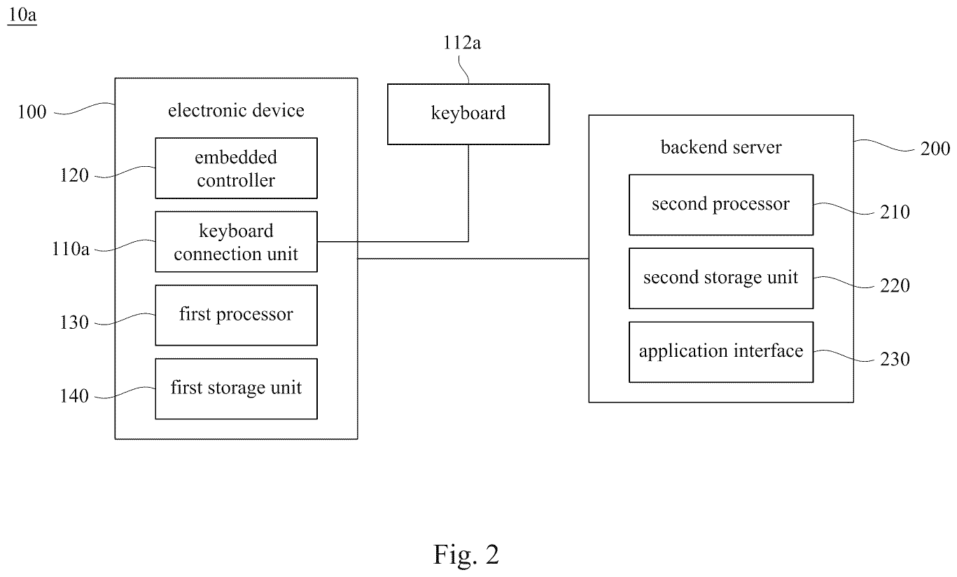

FIG. 2 is a block diagram of a keyboard remote control system 10a according to another embodiment of the present disclosure. The difference between the keyboard remote control system 10a and the keyboard remote control system 10 is that the keyboard connection unit 110a includes, for example, a USB port or Bluetooth for connecting to an external keyboard 112a.

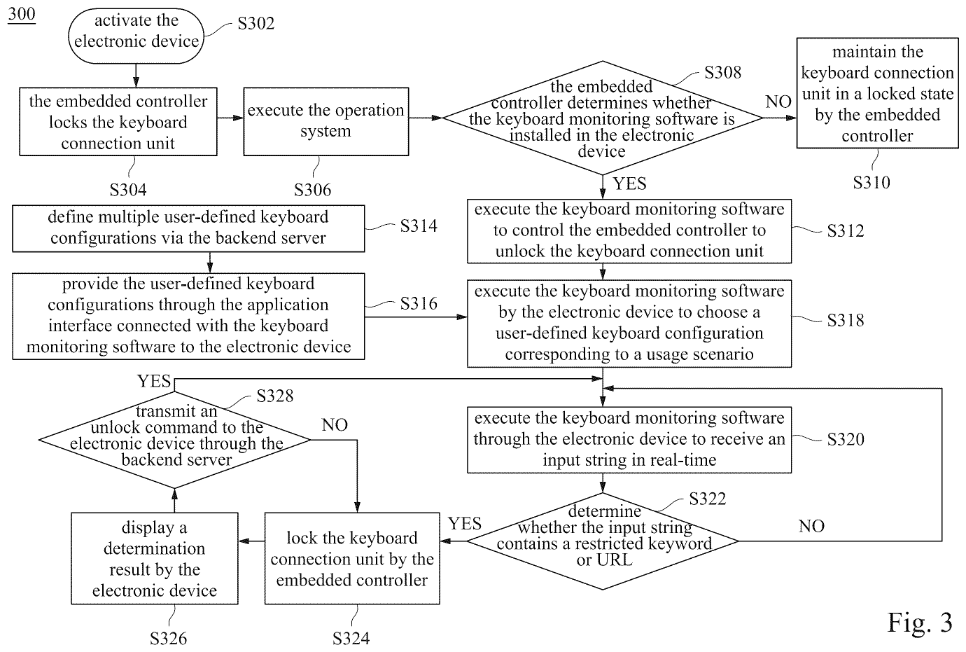

FIG. 3 is a flow chart of a keyboard remote control method 300 according to an embodiment of the present disclosure. Reference is made to FIG. 1 and FIG. 3. The keyboard remote control method 300 begins with step S302, in which the electronic device 100 is activated. Continue to step S304, in which the embedded controller 120 locks the keyboard connection unit 110 of the electronic device 100. Continue to step S306, the operation system is executed by the electronic device 100. The steps mentioned above can avoid unauthorized operation system reinstallation or data theft by locking the keyboard connection unit 110 before executing the operation system.

The keyboard remote control method 300 continues to step S308, in which the embedded controller 120 determines whether the keyboard monitoring software is installed in the electronic device 100. If no keyboard monitoring software is installed, then a step S310 is performed. The keyboard connection unit 110 is maintained in a locked state by the embedded controller 120. If a keyboard monitoring software is installed, then a step S312 is performed. The keyboard monitoring software is executed by the electronic device 100 to control the embedded controller 120 to unlock the keyboard connection unit 110.

In step S308, the keyboard monitoring software transmits a command for unlocking, such that a determination result in step S312 shows that the keyboard monitoring software is installed. In step S312, the embedded controller 120 recognizes the specific verification signals, such as security token or network authentication, and then the keyboard connection unit 110 can be unlocked. The first processor 130 reads the command stored in the first storage unit 140 to execute the keyboard monitoring software. Through the above-mentioned steps, the keyboard 112 of the electronic device 100 can be ensured to remain locked when the electronic device 100 is lost or falls into a third party. Only when the keyboard monitoring software requests a command for unlocking and the embedded controller 120 receives a verification signal can the keyboard connection unit 110 be unlocked. As such, the security control is enhanced when the device is lost.

The keyboard remote control method 300 continues to step S314, step S316, and step S318. In step S314, multiple user-defined keyboard configurations are defined via the backend server 200. In step S316, the user-defined keyboard configurations are provided through the application interface 230 connected with the keyboard monitoring software to the electronic device 100 to control the keyboard 112. In step S318, the keyboard monitoring software is executed by the electronic device 100 to choose a user-defined keyboard configuration corresponding to a usage scenario. Step S314 and step S316 can be preset operations, and the backend server 200 allows the users to manage and update the user-defined keyboard configuration.

In step S314, the users can define disabled keys and enabled keys. For example, the user-defined keyboard may include group A, group B, and group C. The keyboard configuration of the group A is used for login function. The enabled keys are defined as alphabetic keys, number keys, Enter key, ESC key, and the rest of the keys are disabled keys. The keyboard configuration of the group B is used for general user operation. The enabled keys are defined as number keys, Enter key and direction keys, and the rest of the keys are disabled keys. The keyboard configuration of the group C is used for off time or rest time, that is, the keyboard is locked to avoid usage. All the keys are defined as disabled keys.

The keyboard remote control method 300 continues to step S320, step S322, step S324, and step S326. In step S320, the keyboard monitoring software is executed through the electronic device 100 to receive an input string in real-time based on a user-defined keyboard configuration. The keyboard monitoring software can monitor the keyboard input from the users based on the chosen disabled keys and enabled keys. For example, keyboard events can be monitored through Windows API (such as SetWindowsHookEx) or Linux's evdev interface. When the keyboard monitoring software receives a keyboard event, it can determine whether the keys of the keyboard event is included in the enabled keys according to the user-defined keyboard configuration, so as to choose to intercept the keyboard event or not.

In step S322, a text filter is executed through the electronic device 100 to determine whether the input string contains a restricted keyword or URL. The keyboard monitoring software performs pattern matching on the input string, for example, identifying whether the URL (Uniform Resource Locator) of a prohibited website is entered.

In step S324, when the input string contains the restricted keyword or URL, the keyboard connection unit 110 is locked by the embedded controller 120 of the electronic device 100 to avoid inappropriate use. In step S326, a determination result is displayed by the electronic device 100. The electronic device 100 displays a message indicating an input string violation. The step S324 and the step S326 can be performed simultaneously. In step S324, when the input string does not contain the restricted keyword or URL, the method goes back to step S320. Through the method above, only specific keys can be used under specific scenario, such as police or military use, thereby preventing unintended shortcut key activations from disrupting software functionality.

The keyboard remote control method 300 continues to step S328, after the embedded controller 120 of the electronic device 100 locks the keyboard connection unit 110, an unlock command is transmitted to the electronic device 100 through the backend server 200. In step S328, after the keyboard connection unit 110 is locked, the embedded controller 120 transmits a command to ask the backend server 200 whether the keyboard connection unit 110 is required to be unlocked to activate the keyboard 112. The users can use the application interface 230 of the backend server 200 to control the embedded controller 120 of the electronic device 100 to unlock the keyboard connection unit 110. If the unlock process is not executed, then the keyboard remote control method 300 goes back to step S324. In addition, when the electronic device 100 is lost, the users can lock the keyboard connection unit 110 through the application interface 230 of the backend server 200 immediately.

Since the above-mentioned control method can be achieved through the remote control performed by the backend server 200 and the keyboard monitoring software of the electronic device 100, the keyboard 112 can be locked immediately to avoid inappropriate use even when the electronic device 100 is lost or falls into a third party. Lastly, the keyboard remote control method goes back to step S320, and step S322 through step S328 are performed continuously.

In summary, the keyboard remote control method of the present disclosure only allow unlocking the keyboard connection unit to avoid unauthorized operation system reinstallation or data theft when the electronic device is determined to have a keyboard monitoring software and is authorized by using the embedded controller to lock the keyboard connection unit before the operation system is executed by the electronic device. The user-defined keyboard configurations defined and provided by the backend server and the keyboard monitoring software of the electronic device are used for remote monitoring and interception of inappropriate keyboard input. To avoid software operation being disrupted by unintended shortcut key activations, only specific keys can be used under specific scenario. Since the above-mentioned control method can be achieved through the remote control, the keyboard can be locked immediately to avoid inappropriate use even when the electronic device is lost or falls into a third party.

Although the present invention has been described in considerable detail with reference to certain embodiments thereof, other embodiments are possible. Therefore, the spirit and scope of the appended claims should not be restricted to the description of the embodiments contained herein.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims.

What is claimed is:

1. A keyboard remote control method, comprising:
responding to an activation of an electronic device, locking a keyboard connection unit of the electronic device through an embedded controller of the electronic device before an operation system of the electronic device is executed; and
executing a keyboard monitoring software through the electronic device to control the embedded controller to unlock or lock the keyboard connection unit.

2. The keyboard remote control method of claim 1, further comprising:
after the operation system of the electronic device is executed, determining whether the keyboard monitoring software is installed in the electronic device through the embedded controller.

3. The keyboard remote control method of claim 2, wherein when no keyboard monitoring software is installed in the electronic device, the embedded controller locks the keyboard connection unit of the electronic device.

4. The keyboard remote control method of claim 1, further comprising:
defining a user-defined keyboard configuration through a backend server; and
providing the user-defined keyboard configuration to the electronic device to control a keyboard connected with the electronic device through an application interface connected with the keyboard monitoring software.

5. The keyboard remote control method of claim 4, wherein defining the user-defined keyboard configuration through the backend server comprises:
defining a disabled key and an enabled key.

6. The keyboard remote control method of claim 1, further comprising:
executing the keyboard monitoring software through the electronic device to choose a user-defined keyboard configuration corresponding to a usage scenario.

7. The keyboard remote control method of claim 1, further comprising:
executing the keyboard monitoring software through the electronic device to receive an input string in real-time based on a user-defined keyboard configuration; and
executing a text filter through the electronic device to determine whether the input string contains a restricted keyword or a uniform resource locator (URL).

8. The keyboard remote control method of claim 7, wherein when the input string contains the restricted keyword or the URL, the keyboard remote control method further comprises:
locking the keyboard connection unit through the embedded controller of the electronic device.

9. The keyboard remote control method of claim 8, further comprising:
after the embedded controller of the electronic device locks the keyboard connection unit of the electronic device, transmitting an unlock command to the electronic device through a backend server.

10. The keyboard remote control method of claim 7, wherein when the input string contains the restricted keyword or the URL, the keyboard remote control method further comprises:
displaying a determination result through the electronic device.

11. A keyboard remote control system, comprising:
an electronic device, comprising:
a keyboard connection unit;
an embedded controller configured to lock the keyboard connection unit of the electronic device before an operation system of the electronic device is executed; and
a first processor configured to read at least one command stored in a first storage unit so as to execute the following step:
controlling the embedded controller to unlock or lock the keyboard connection unit.

12. The keyboard remote control system of claim 11, wherein after executing the operation system of the electronic device, the embedded controller is configured to determine whether the first storage unit of the electronic device contains a command used to receive an input string in real-time.

13. The keyboard remote control system of claim 11, further comprising:
a backend server configured to define a user-defined keyboard configuration, wherein the backend server comprises:
a second processor configured to read the user-defined keyboard configuration stored in a second storage unit; and
an application interface connected with the first processor of the electronic device and configured to provide the user-defined keyboard configuration to the electronic device so as to control a keyboard connected with the electronic device.

14. The keyboard remote control system of claim 13, wherein the user-defined keyboard configuration comprises a disabled key and an enabled key.

15. The keyboard remote control system of claim 11, wherein the keyboard connection unit comprises a universal serial bus (USB) port or a Bluetooth.

16. The keyboard remote control system of claim 11, wherein the first processor of the electronic device is further configured to determine whether an input string contains a restricted keyword or a uniform resource locator (URL).

17. The keyboard remote control system of claim 16, wherein when the input string contains the restricted keyword or the URL, the embedded controller of the electronic device is configured to lock the keyboard connection unit of the electronic device.

18. The keyboard remote control system of claim 17, further comprising:
a backend server, wherein after the embedded controller of the electronic device locks the keyboard connection unit of the electronic device, the backend server is configured to transmit an unlock command to the electronic device.

19. The keyboard remote control system of claim 11, wherein the first processor is further configured to choose a user-defined keyboard configuration corresponding to a usage scenario.

20. The keyboard remote control system of claim 17, wherein the electronic device is further configured to display a determination result.
